(19) United States
(12) Patent Application Publication
(10) Pub. No.: US 2019/0094192 A1
(43) Pub. Date: Mar. 28, 2019

(54) METHOD FOR THE DETERMINATION OF A CONCENTRATION OF A POLYACRYLIC ACID IN AN AQUEOUS MEDIUM

(71) Applicant: BASF SE, Ludwigshafen (DE)

(72) Inventors: Hans-Peter KAUB, Altrip (DE); Patrick KELLER, Lustadt (DE); Sujandi SUJANDI, Singapore (SG); Stephan NIED, Neustadt / Wstr. (DE)

(73) Assignee: BASF SE, Ludwigshafen (DE)

(21) Appl. No.: 15/527,148

(22) PCT Filed: Nov. 18, 2015
(86) PCT No.: PCT/EP2015/002303

§ 371 Date: May 16, 2017

(30) Foreign Application Priority Data
Nov. 18, 2014 (EP) 14193640.1

(51) Int. Cl. G01N 31/22; G01N 21/78

(52) U.S. Cl. CPC G01N 31/22; C09B 19/00; G01N 21/78

(57) ABSTRACT

The present invention relates to a method for the determination of a concentration (C) of a polyacrylic acid (PAA) in an aqueous medium (AM) wherein the determination is performed photometrically in the presence of a dye (I). The present invention furthermore, relates to a method for the determination of a concentration (C) of a polyacrylic acid (PAA) in an aqueous medium (AM) wherein at least two different transmittance values are measured using at least two different wavelengths and wherein the at least two different transmittance values are analyzed to determine the concentration (C) of the polyacrylic acid (PAA). The present invention also relates to the use of a dye (I) for the determination of the concentration (C) of a polyacrylic acid (PAA).

The present invention relates to a method for the determination of a concentration (C) of a polyacrylic acid (PAA) in an aqueous medium (AM) wherein the determination is performed photometrically in the presence of a dye (I). The present invention furthermore, relates to a method for the determination of a concentration (C) of a polyacrylic acid (PAA) in an aqueous medium (AM) wherein at least two different transmittance values are measured using at least two different wavelengths and wherein the at least two different transmittance values are analyzed to determine the concentration (C) of the polyacrylic acid (PAA). The present invention also relates to the use of a dye (I) for the determination of the concentration (C) of a polyacrylic acid (PAA).

In boilers, pipings and other components of water treatment plants, of desalination plants and of water circuits, especially of cooling water circuits of industrial plants and of power plants, often scale (incrustation) forms due to the deposition of for example calcium carbonate (CaCO₃, calcite) and magnesium carbonate (MgCO₃). This leads to high costs as frequent cleaning of the boilers, pipings and the other components is necessary. Furthermore, the scale (incrustation) can lead to a shortening of the lifetime of the plants as it can lead to severe damages of the boilers, pipings and other components of the plants.

To inhibit the scale (incrustation) growth, so-called incrustation inhibitors are added to the water comprised in the water circuits, in the water treatment plants and in the desalination plants. It is assumed, that the incrustation inhibitors inhibit the formation of scale (incrustation) by colloidal stabilization of precursors, that otherwise would form scale (incrustation) like for example calcite deposit. Incrustation inhibitors are for example polyacrylic acids and polyaspartic acid. During the inhibition process, the incrustation inhibitor is consumed and therefore its concentration drops. When its concentration is below a certain level the incrustation inhibitor cannot inhibit the growth of scale (incrustation) any longer. Therefore, it is necessary to keep the level of the concentration of the incrustation inhibitor at a certain value.

To monitor the concentration of the incrustation inhibitor several methods are described in the state of the art.

WO 02/184558 A1 describes a method for determining the concentration of polyaspartic acid and salts thereof in an aqueous medium using fluorescence spectroscopy.

This method is only suitable if the incrustation inhibitor itself is fluorescent. Otherwise, it is necessary to chemically label the incrustation inhibitor or to add a fluorescence label to the aqueous medium, which comprises the incrustation inhibitor. However, the correlation between the concentration of the fluorescence label and the concentration of the incrustation inhibitor is not at all easy, for example, because the fluorescence label and the incrustation inhibitor may exhibit different breakdown behaviors. Furthermore, it is not sure that chemically labelled incrustation inhibitors behave in the same way as incrustation inhibitors that are not chemically labelled.

D. Horn, Optisches Zweistrahlverfahren zur Bestimmung von Polyelektrolyten in Wasser and zur Messung der Polymeradsorption an Grenzflächen, Progr. Colloid & Polymer Sci. 1978, 65, 251-264 describes the determination of the concentration of an incrustation inhibitor by titration of the incrustation inhibitor, which is an anionic polyelectrolyte, with a cationic polyelectrolyte wherein the endpoint is determined colorimetric by addition of a metachromatic dye like toluidine blue, methylene blue, crystal violet, acridin orange, proflavine or pyronin G. However, this process is very complex and not automatable. Moreover, the colorimetric endpoint determination is only possible in demineralized water and therefore not suitable for cooling water circuits and desalination plants.

The object underlying the present invention is therefore to provide a method for the determination of the concentration (C) of a polyacrylic acid (PAA) in an aqueous medium (AM) which does not have the above mentioned disadvantages of the prior art or has them only to a significantly reduced extend.

This object is achieved by a method for the determination of a concentration (C) of a polyacrylic acid (PAA) in an aqueous medium (AM), which comprises the polyacrylic acid (PAA), wherein the determination is performed photometrically in the presence of a dye of the general formula (I)

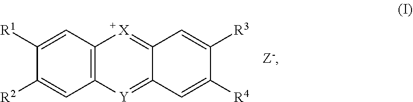

wherein
R¹ is selected from the group consisting of H, C₁-C₁₀-alkyl, C₆-C₁₀-aryl and NR⁵R⁶,
wherein
R⁵ and Ware independently of one another selected from the group consisting of H, C₁-C₁₀-alkyl and C₆-C₁₀-aryl;
R² is selected from the group consisting of H, C₁-C₁₀-alkyl, C₆-C₁₀-aryl and NR⁷R⁸,
wherein
R⁷ and R⁸ are independently of one another selected from the group consisting of H, C₁-C₁₀-alkyl and C₆-C₁₀-aryl;
R³ is selected from the group consisting of H, C₁-C₁₀-alkyl, C₆-C₁₀-aryl and NR⁹R¹⁰,
wherein
R⁹ and R¹⁰ are independently of one another selected from the group consisting of H, C₁-C₁₀-alkyl and C₆-C₁₀-aryl;
R⁴ is selected from the group consisting of H, C₁-C₁₀-alkyl, C₆-C₁₀-aryl and NR¹¹R¹²,
wherein
R¹¹ and R¹² are independently of one another selected from the group consisting of H, C₁-C₁₀-alkyl and C₆-C₁₀-aryl;
X⁺ is selected from the group consisting of NH⁺, O⁺ and S⁺;
Y is N or CH;
Z⁻ is selected from the group consisting of OH⁻, F⁻, Cl⁻, Br, I⁻, SO₄²⁻, PO₄³⁻, HCO₃⁻ and CO₃²⁻.

Another object of the present invention is a method for the determination of a concentration (C) of a polyacrylic acid (PAA) in an aqueous medium (AM), which comprises the polyacrylic acid (PAA), comprising the steps:

a) providing the aqueous medium (AM), which comprises the polyacrylic acid (PAA), comprising the steps:
a1) providing an electrolyte-containing aqueous medium (EAM), which comprises the polyacrylic acid (PAA) and at least one electrolyte,
a2) passing the electrolyte-containing aqueous medium (EAM) through a dialysis unit to give a dialyzed aqueous medium, which comprises the polyacrylic acid (PAA) and
a3) adding deionized water to the dialyzed aqueous medium obtained in step a2) to obtain the aqueous medium (AM),

b) addition of the dye (I) to the aqueous medium (AM) to obtain a dye-containing aqueous medium (DAM), which comprises the polyacrylic acid (PAA) and the dye (I),

c) providing the dye-containing aqueous medium (DAM) obtained in step b) to a photometer,

d) using at least two different wavelengths to measure at least two different transmittance values of the dye-containing aqueous medium (DAM) using the photometer and

e) analysing the at least two different transmittance values obtained in step d) to determine the concentration (C) of the polyacrylic acid (PAA).

Another object of the present invention is the use of a dye (I) for the determination of a concentration (C) of a polyacrylic acid (PAA) via photometry.

It has surprisingly been found that the concentration (C) of a polyacrylic acid (PAA) can be determined by photometric methods in the presence of a dye (I). With the inventive method, the concentration (C) of the polyacrylic acid (PAA) can be determined very accurate and the obtained values are highly reproducible. Moreover, the method can easily be automated. The inventive process allows the determination of the concentration (C) of a polyacrylic acid (PAA) continuous.

Moreover, as in one preferred embodiment of the present invention, the aqueous medium (AM) is provided by dialysis, the inventive method is also suitable for the determination of the concentration (C) of a polyacrylic acid (PAA), which is comprised in cooling water or water of desalination plants.

As in one embodiment of the present invention the measurement of only two transmittance values using two different wavelength is necessary the photometer used for the determination of the concentration (C) of the polyacrylic acid (PAA) can be constructed in a more simple manner and is less prone to errors than the measuring devices used in the state of art

A detailed description of the inventive method can be found hereinafter.

### Polyacrylic Acid (PAA)

Within the context of the present invention the term “a polyacrylic acid (PAA)” means precisely one polyacrylic acid (PAA) and also a mixture of two or more polyacrylic acids (PAA).

The term “polyacrylic acid (PAA)” comprises homopolymers prepared from a monoethylenically unsaturated monocarboxylic acid, copolymers prepared from a monoethylenically unsaturated monocarboxylic acid and at least one comonomer and also mixtures of these homopolymers and copolymers.

Suitable monoethylenically unsaturated monocarboxylic acids are known to the skilled person. Monoethylenically unsaturated (C₃-C₇)-monocarboxylic acids are preferred. Particularly preferably the monoethylenically unsaturated monocarboxylic acid is selected from the group consisting of acrylic acid, methacrylic acid, crotonic acid and vinylacetic acid.

Suitable comonomers for the preparation of copolymers are known to the skilled person.

Preferably, the at least one comonomer is selected from the group consisting of methacrylic acid, crotonic acid, maleic acid or maleic anhydride, itaconic acid, fumaric acid, citracronic acid and citracronic anhydride, vinylphosphonic acid, vinylsulfonic acid, 2-acrylamido-2-methylpropanesulfonic acid (AMPS), (meth)acrylic acid derivatives, for example hydroxyethyl acrylate, hydroxypropyl acrylate, hydroxybutyl acrylate, (meth)acrylamide, vinylformamide, alkali metal (3-methacryloyloxy)propanesulfonate, dimethylaminoethyl acrylate, 2-acryloyloxyethyltrimethylammonium chloride, dimethylamino methacrylate and polyethylene glycol methyl ether(meth)acrylate. Particularly preferred the at least one comonomer is selected from the group consisting of maleic acid, maleic anhydride and 2-acrylamido-2-methyl-propanesulfonic acid (AMDS).

The monoethylenically unsaturated monocarboxylic acid and the at least one comonomer can be used in the form of free acids or else in completely or partly neutralized form for the preparation of the homopolymer and for the preparation of the copolymer.

The person skilled in the art knows that “free acids” means that the acidic groups of the monoethylenically unsaturated monocarboxylic acid and the at least one comonomer are present in their protonated form. For example carboxyl-groups are present as COOH. “Neutralized form” means that the acidic groups of the monoethylenically unsaturated monocarboxylic acid and the at least one comonomer are present in their deprotonated form, for example as a salt. Carboxyl-groups in their neutralized form for example means carboxylate groups (COO⁻). “Partly neutralized form” means that some of the acidic groups of the monoethylenically unsaturated monocarboxylic acid and the at least one comonomer are present as free acids and some are present in their neutralized form.

It should be clear that in case that the polyacrylic acid (PAA) is a copolymer, the monoethylenically unsaturated monocarboxylic acid differs from the at least one comonomer.

In case that the polyacrylic acid (PAA) is a copolymer, a copolymer selected from the group consisting of a poly(acrylic acid-maleic acid)-copolymer, a poly(acrylic acid-maleic anhydride)-copolymer or a poly(acrylic acid-2-acrylamido-2-methylpropane-sulfonic acid)-copolymer is particularly preferred.

In a further preferred embodiment of the present invention the polyacrylic acid (PAA) is prepared from at least 50% by weight, preferably at least 80% by weight and more preferably at least 95% by weight of acrylic acid, based on the total amount of the acrylic acid and the at least one comonomer from which the polyacrylic acid (PAA) is prepared.

Methods for the preparation of polyacrylic acid (PAA) are known to the skilled person. Methods for its preparation are for example described in US 2012/0214041 A1 and in WO 2012/001092 A1. For example the polyacrylic acid (PAA) can be prepared by free-radical polymerization.

The polyacrylic acid (PAA) preferably has a weight average molecular weight M_{w} in the range from 800 to 250000 g/mol measured by size exclusion chromatography (SEC) using a sodium polyacrylic acid standard and a polyacrylic acid standard for the calibration.

The polyacrylic acid (PAA) preferably has a number average molecular weight Mₙ (determinable by means of gel permeation chromatography, GPC (also known as size exclusion chromatography, SEC) in an aqueous medium) in the range from 1000 g/mol to 250000 g/mol, preferably in the range from 1000 g/mol to 70000 g/mol and more preferably in the range from 1000 g/mol to 8000 g/mol.

Another object of the present invention is therefore a method, wherein the polyacrylic acid (PAA) has a number average molecular weight Mₙ in the range from 1000 to 250000 g/mol.

### Aqueous Medium (AM)

In one embodiment of the method according to the present invention in step a), the aqueous medium (AM), which comprises the polyacrylic acid (PAA), is provided by dialysis.

Step a)

Step a) preferably comprises the steps:
a1) providing an electrolyte-containing aqueous medium (EAM), which comprises the polyacrylic acid (PAA) and at least one electrolyte,

a2) passing the electrolyte-containing aqueous medium (EAM) through a dialysis unit to give a dialyzed aqueous medium, which comprises the polyacrylic acid (PAA) and

a3) adding deionized water to the dialyzed aqueous medium obtained in step a2) to obtain the aqueous medium (AM).

In one embodiment, step a2) and step a3) are carried out simultaneously.

Therefore, another object of the present invention is a method, wherein step a2) and step a3) are carried out simultaneously.

To the person skilled in the art it should be clear that the electrolyte-containing aqueous medium (EAM) differs from the aqueous medium (AM).

The electrolyte-containing aqueous medium (EAM) can be provided by any method known to the skilled person.

In one embodiment of the present invention, in step a1) the electrolyte-containing aqueous medium (EAM) is provided by removing a portion of a process stream to obtain the electrolyte-containing medium (EAM). A process stream for example is a cooling water circuit in industrial plants or in power plants or a water stream of a water treatment plant or of a desalination plant. Therefore, in one embodiment of the present invention the electrolyte-containing aqueous medium (EAM) is selected from the group consisting of distilled water, tap water, river water, sea water and mixtures thereof. Preferably, the electrolyte-containing aqueous medium (EAM) is selected from the group consisting of tap water, river water and sea water.

The temperature of the electrolyte-containing aqueous medium (EAM) is generally in the range from >0 to <100° C. Preferably, the temperature of the electrolyte-containing aqueous medium (EAM) is in the range from 5 to 95° C. and particularly preferably in the range from 10 to 50° C.

The electrolyte-containing aqueous medium (EAM) can have any pH-value. Preferably, the pH-value of the electrolyte-containing aqueous medium (EAM) is in the range from 5 to 9, particularly preferably in the range from 6 to 8 and more preferably in the range from 6.5 to 7.5.

According to the present invention the electrolyte-containing aqueous medium (EAM) comprises the polyacrylic acid (PAA) and at least one electrolyte.

“At least one electrolyte” within the context of the present invention means precisely one electrolyte and also a mixture of two or more electrolytes.

In one embodiment the electrolyte-containing aqueous medium (EAM) comprises in the range from 0.01 to 100 ppmw of the polyacrylic acid (PAA), preferably from 0.1 to 60 ppmw, particularly preferably from 0.1 to 40 ppmw and more preferably from 0.1 to 20 ppmw of the polyacrylic acid (PAA) based on the total amount of the electrolyte-containing aqueous medium (EAM). “ppmw” within the context of the present invention means parts per million by weight. 1 ppmw means 0.0001% by weight.

The electrolyte-containing aqueous medium (EAM) generally comprises in the range from 0.001 to 10% by weight of the at least one electrolyte, preferably from 0.005 to 7.5% by weight, particularly preferably from 0.01 to 5% by weight and more preferably from 0.02 to 4% by weight of the at least one electrolyte based on the total amount of the electrolyte-containing aqueous medium (EAM).

Another object of the present invention is therefore a method, wherein the electrolyte-containing aqueous medium (EAM) comprises from 0.001 to 10% by weight of the at least one electrolyte, based on the total amount of the electrolyte-containing aqueous medium (EAM).

The at least one electrolyte comprises an inorganic salt. To the person skilled in the art it should be clear that the at least one electrolyte differs from the polyacrylic acid (PAA).

In one embodiment of the present invention, the at least one electrolyte comprises sea salt. The person skilled in the art knows typical compositions of sea salt.

In another embodiment of the present invention the at least one electrolyte is selected from the group consisting of an alkaline metal salt, an alkaline earth metal salt and mixtures thereof.

In another embodiment of the present invention the at least one electrolyte is selected from the group consisting of an alkaline metal salt, an alkaline earth metal salt, an iron oxide and mixtures thereof.

Another object of the present invention is therefore a method, wherein the electrolyte-containing aqueous medium (EAM) comprises at least one electrolyte selected from the group consisting of an alkaline metal salt, an alkaline earth metal salt and mixtures thereof.

Alkaline metal salts and alkaline earth metal salts are known to the skilled person. Preferred alkaline metal salts are for example sodium sulfate (Na₂SO₄), sodium chloride (NaCl), sodium bromide (NaBr), sodium iodide (Nal), sodium carbonate (Na₂CO₃), potassium chloride (KCl), potassium bromide (KBr) and potassium iodide (KI). Preferred alkaline earth metal salts are for example calcium fluoride (CaF₂), calcium sulfate (CaSO₄), calcium carbonate (CaCO₃), magnesium fluoride (MgF₂), magnesium chloride (MgCl₂), magnesium bromide (MgBr₂), Magnesium iodide (MgI₂), magnesium sulfate (MgSO₄), magnesium carbonate (MgCO₃) and magnesium hydroxide (Mg(OH)₂).

The person skilled in the art knows that alkaline metal salts and alkaline earth metal salts generally dissociate in water. For example sodium chloride (NaCl) dissociates in water to give a sodium cation (Na⁺) and a chloride anion (Cl⁻), sodium carbonate (Na₂CO₃) dissociates in an aqueous medium (AM) to form two sodium cations (Na⁺) and a carbonate anion (CO₃²⁻) and calcium carbonate (CaCO₃) dissociates to give a calcium cation (Ca²⁺) and a carbonate anion (CO₃²⁻). A carbonate anion can also form bicarbonate (HCO₃⁻) in water. Therefore, alkaline metal salts and alkaline earth metal salts in water are usually present in their ionic form.

Therefore, in one embodiment of the present invention the electrolyte-containing aqueous medium (EAM) comprises at least one electrolyte, selected from the group consisting of sulfate (SO₄²⁻), fluoride (F⁻), chloride (Cl⁻), bromide (Br⁻), iodide (I⁻), carbonate (CO₃²⁻), bicarbonate (HCO₃⁻), hydroxide (OH⁻), sodium (Na⁺), potassium (K⁺), calcium (Ca²⁺), magnesium (Mg²⁺) and mixtures thereof.

In another embodiment of the present invention the electrolyte-containing aqueous medium (EAM) comprises at least one electrolyte selected from the group consisting of sulfate (SO₄²⁻), fluoride (F⁻), chloride (Cl⁻), bromide (Br⁻), iodide (I⁻), carbonate (CO₃²⁻), bicarbonate (HCO₃⁻), hydroxide (OH⁻), sodium (Na⁺), potassium (K⁺), calcium (Ca²⁺), magnesium (Mg²⁺), iron (Fe²⁺ and/or Fe³⁺) and mixtures thereof.

The person skilled in the art knows that the charge of one of the above mentioned ions is usually compensated by counter ions having the opposite charge. If the electrolyte-containing aqueous medium (EAM) comprises an anion, the electrolyte-containing aqueous medium (EAM) usually as well comprises a cation.

In one embodiment of the present invention, the electrolyte-containing aqueous medium (EAM) therefore comprises at least two electrolytes, wherein the first electrolyte is selected from the group consisting of sulfate (SO₄²⁻), fluoride (F⁻), chloride (Cl⁻), bromide (Br⁻), iodide (I⁻), carbonate (CO₃²⁻), bicarbonate (HCO₃⁻), hydroxide (OH⁻) and mixtures thereof and wherein the second electrolyte is selected from the group consisting of sodium (Na⁺), potassium (K⁺), calcium (Ca²⁺), magnesium (Mg²⁺) and mixtures thereof.

Therefore, in one embodiment of the present invention the aqueous medium (AM) comprises at least one electrolyte, selected from the group consisting of sulfate (SO₄²⁻), fluoride (F⁻), chloride (Cl⁻), bromide (Br⁻), iodide (I⁻), carbonate (CO₃²⁻), bicarbonate (HCO₃⁻), hydroxide (OH⁻), sodium (Na⁺), potassium (K⁺), calcium (Ca²⁺), magnesium (Mg²⁺) and mixtures thereof.

In another embodiment of the present invention the aqueous medium (AM) comprises at least one electrolyte selected from the group consisting of sulfate (SO₄²⁻), fluoride (F⁻), chloride (Cl⁻), bromide (Br⁻), iodide (I⁻), carbonate (CO₃²⁻), bicarbonate (HCO₃⁻), hydroxide (OH⁻), sodium (Na⁺), potassium (K⁺), calcium (Ca²⁺), magnesium (Mg²⁺), iron (Fe²⁺ and/or Fe³⁺0 and mixtures thereof.

The person skilled in the art knows that the charge of one of the above mentioned ions is usually compensated by counter ions having the opposite charge. If the aqueous medium (AM) comprises an anion, the aqueous medium (AM) usually as well comprises a cation.

In one embodiment of the present invention, the aqueous medium (AM) therefore comprises at least two electrolytes, wherein the first electrolyte is selected from the group consisting of sulfate (SO₄²⁻), fluoride (F⁻), chloride (Cl⁻), bromide (Br⁻), iodide (I⁻), carbonate (CO₃²⁻), bicarbonate (HCO₃⁻), hydroxide (OH⁻) and mixtures thereof and wherein the second electrolyte is selected from the group consisting of sodium (Na⁺), potassium (K⁺), calcium (Ca²⁺), magnesium (Mg²⁺) and mixtures thereof.

In one embodiment of the present invention, the aqueous medium (AM) therefore comprises at least two electrolytes, wherein the first electrolyte is selected from the group consisting of sulfate (SO₄²⁻), fluoride (F⁻), chloride (Cl⁻), bromide (Br⁻), iodide (I⁻), carbonate (CO₃²⁻), bicarbonate (HCO₃⁻), hydroxide (OH⁻) and mixtures thereof and wherein the second electrolyte is selected from the group consisting of sodium (Na⁺), potassium (K⁺), calcium (Ca²⁺), magnesium (Mg²⁺), iron (Fe²⁺ and/or Fe³⁺) and mixtures thereof.

The electrolyte-containing aqueous medium (EAM) generally comprises at least 50% by weight, preferably at least 80% by weight and particularly preferably at least 90% by weight of water, based on the total amount of the electrolyte-containing aqueous medium (EAM).

In a preferred embodiment of the present invention the electrolyte-containing aqueous medium (EAM) comprises from 89.99% to 99.999% by weight of water, preferably from 92.494% to 99.995% by weight, particularly preferably from 94.996% to 99.99% by weight and more preferably from 95.998% to 99.98% by weight of water, based on the total amount of the electrolyte-containing aqueous medium (EAM).

The electrolyte-containing aqueous medium (EAM), moreover, optionally comprises at least one further solvent. Generally, the electrolyte-containing aqueous medium (EAM) comprises at most 10% by weight, preferably at most 5% by weight, more preferably at most 2% by weight of the at least one further solvent, based on the total weight of the electrolyte-containing aqueous medium (EAM).

The ppmw of the polyacrylic acid (PAA), the % by weight of the at least one electrolyte and the % by weight of water and optionally the % by weight of a further solvent, comprised in the electrolyte containing aqueous medium (EAM) generally add up to 100%.

Suitable at least one further solvents are known to the skilled person. The at least one further solvent exhibits no miscibility gap with water. For example, the at least one solvent is a polar solvent, selected from the group consisting of methanol, ethanol, propanol and glycol.

The conductivity of the electrolyte-containing aqueous medium (EAM) is in one embodiment of the present invention in the range from 10 to 100000 μS/cm², preferably in the range from 10 to 30000 μS/cm² and particularly in the range from 10 to 500 μS/cm².

In step a2) the electrolyte-containing aqueous medium (EAM) is passed through the dialysis unit to give a dialyzed aqueous medium which comprises the polyacrylic acid (PAA). The electrolyte-containing aqueous medium (EAM) is usually passed through the dialysis unit by pumping.

In the dialysis unit of step a2) at least a part of the at least one electrolyte is removed from the electrolyte-containing aqueous medium (EAM) by dialysis to give the dialyzed aqueous medium. “At least a part of the at least one electrolyte” within the context of the present invention means from 10 ppm to 5% of the at least one electrolyte comprised in the electrolyte-containing aqueous medium (EAM) are removed, preferably from 10 ppm to 1% and particularly preferably from 10 ppm to 100 ppm.

The principle of dialysis and suitable dialysis units are known to the skilled person. Generally, a dialysis unit comprises a buffer solution and at least one semipermeable membrane. The semipermeable membrane separates the electrolyte-containing aqueous medium (EAM) from the buffer solution. The buffer solution has a lower concentration of the at least one electrolyte than the electrolyte-containing aqueous medium (EAM). Therefore, to reach equilibrium between the concentration of the at least one electrolyte comprised in the electrolyte-containing aqueous medium (EAM) and the concentration of the at least one electrolyte comprised in the buffer solution, the at least one electrolyte comprised in the electrolyte-containing aqueous medium (EAM) diffuses through the semi-permeable membrane into the buffer solution.

To prevent the passage of the polyacrylic acid (PAA) molecules from the electrolyte-containing aqueous medium (EAM) to the buffer solution through the semi-permeable membrane usually a semi-permeable membrane having a pore size smaller than the size of the polyacrylic acid (PAA) molecules is used. The pore size of the semi-permeable membrane is for example ≤10000 Da, preferably ≤5000 Da and particularly preferably ≤1000 Da.

In one embodiment the pore size of the semi-permeable membrane is in the range from 100 to 10000 Da, preferably from 300 to 5000 Da and particularly preferably from 500 to 1000 Da.

The semi-permeable membrane can have various forms, for example the form of a tube or of a cassette.

The semi-permeable membrane can be made of any material that is suitable for the preparation of semi-permeable membranes and that allows the diffusion of the at least one electrolyte through the semipermeable membrane. Preferably, the semi-permeable membrane is made from cellulose nitrate, cellulose triacetate, cellulose acetate, regenerated cellulose, polyethersulfone, polyamide, polytetraflourethylene, polycarbonate or polyvinylchloride. Particularly preferred, the semi-permeable membrane is made from polyethersulfone.

Suitable buffer solutions are known to the skilled person. Preferably, the buffer solution comprises at least 90% by weight of demineralized water, based on the total amount of the buffer solution. In a particularly preferred embodiment, the buffer solution consists of demineralized water.

It should be clear to the person skilled in the art, that the composition of the buffer solution changes during the dialysis process, as molecules of the at least one electrolyte diffuse into the buffer solution.

During step a2), in which the electrolyte-containing aqueous medium (EAM) is passed through a dialysis unit, usually not only the at least one electrolyte comprised in the electrolyte-containing aqueous medium (EAM) diffuses through the semi-permeable membrane, but also the at least one solvent comprised in the electrolyte-containing aqueous medium (EAM). Therefore, the volume of the electrolyte-containing aqueous medium (EAM) is usually higher than the volume of the dialyzed aqueous medium obtained in step a2).

The dialyzed aqueous medium generally comprises at least one solvent.

The dialyzed aqueous medium usually comprises the same at least one solvent that was comprised in the electrolyte-containing aqueous medium (EAM).

Therefore, for the at least one solvent comprised in the dialyzed aqueous medium the embodiments and preferences stated above for the at least one solvent comprised in the electrolyte-containing aqueous medium (EAM) hold true. Preferably, the at least one further solvent optionally comprised in the electrolyte-containing aqueous medium (EAM) is removed by the dialysis.

Furthermore, the dialyzed aqueous medium comprises the polyacrylic acid (PAA) and usually a residue of the at least one electrolyte, which was comprised in the electrolyte-containing aqueous medium (EAM).

For the polyacrylic acid (PAA) comprised in the dialyzed aqueous medium the embodiments and preferences stated above for the polyacrylic acid (PAA) comprised in the electrolyte-containing aqueous medium (EAM) hold true.

“A residue of the at least one electrolyte” within the present invention means from 0 to 100 ppm by weight of the at least one electrolyte, preferably from 0 to 70 ppm by weight of the at least one electrolyte and particularly preferably from 0 to 30 ppm by weight of the at least one electrolyte, based on the total amount of the dialyzed aqueous medium.

To the person skilled in the art it should be clear that the amount of the residue of the at least one electrolyte comprised in the dialyzed aqueous medium is lower than the amount of the at least one electrolyte comprised in the electrolyte-containing aqueous medium (EAM).

Another object of the present invention is therefore also a method, wherein the amount of the at least one electrolyte comprised in the electrolyte-containing aqueous medium (EAM) is higher than the amount of the at least one electrolyte comprised in the dialyzed aqueous medium.

It should be clear, that the residue of the at least one electrolyte comprised in the dialyzed aqueous medium comprises the same at least one electrolyte as the electrolyte-containing aqueous medium (EAM). Therefore, concerning the residue of the at least one electrolyte comprised in the dialyzed aqueous medium the above stated embodiments and preferences for the at least one electrolyte comprised in the electrolyte-containing aqueous medium (EAM) hold true.

In step a3) deionized water is added to the dialyzed aqueous medium obtained in step a2) to obtain the aqueous medium (AM).

To add deionized water to the dialyzed aqueous medium the dialyzed aqueous medium usually is transferred into a vessel. Suitable vessels are known to the skilled person. In the vessel the deionized water is added to the dialyzed aqueous medium. The deionized water is usually added in an amount so that the volume of the aqueous medium (AM) obtained in step a3) is the same as the volume of the electrolyte-containing aqueous medium (EAM), which was provided in step a1). “The same” within the context of the present invention means a volume difference between the volume of the aqueous medium (AM) obtained in step a3) and the volume of the electrolyte-containing aqueous medium (EAM) provided in step a1) of ±10%, preferably of ±5% and particularly preferably of ±2%.

According to the present invention the aqueous medium (AM) comprises the polyacrylic acid (PM). The aqueous medium (AM) generally comprises in the range from 0.01 to 100 ppmw of the polyacrylic acid (FAA) based on the total amount of the aqueous medium (AM). Preferably the aqueous medium (AM) comprises in the range from 0.1 to 60 ppmw, particularly preferably from 0.1 to 40 ppmw and more preferably from 0.1 to 20 ppmw of the polyacrylic acid (PAA) based on the total weight of the aqueous medium (AM). “ppmw” within the context of the present invention means parts per million by weight. 1 ppmw means 0.0001% by weight.

Another object of the present invention is therefore a method, wherein the aqueous medium (AM) comprises from 0.01 to 100 ppmw of the polyacrylic acid (PAA), based on the total weight of the aqueous medium (AM).

Moreover, the aqueous medium (AM) can comprise at least one further polymer. Suitable further polymers are known to the skilled person. It should be clear that the at least one further polymer optionally comprised in the aqueous medium (AM) differs from the polyacrylic acid (PM) comprised in the aqueous medium (AM). It should furthermore be clear that if the aqueous medium (AM) comprises at least one further polymer, in one preferred embodiment the at least one further polymer is as well comprised in the electrolyte-containing aqueous medium (EAM) and in the dialyzed aqueous medium.

In one embodiment of the present invention the aqueous medium (AM) comprises a residue of the at least one electrolyte.

Another object of the present invention is therefore a method, wherein the aqueous medium (AM) comprises a residue of the at least one electrolyte.

“A residue of at least one electrolyte” within the context of the present invention and the aqueous medium (AM) means a range from 0 to 100 ppmw of at least one electrolyte, preferably from 0 to 70 ppmw of at least one electrolyte and particularly preferably from 0 to 30 ppmw of at least one electrolyte based on the total amount of the aqueous medium (AM).

Therefore in one embodiment the aqueous medium (AM) comprises in the range from 0 to 100 ppmw of the at least one electrolyte, preferably from 0 to 70 ppmw of the at least one electrolyte and particularly preferably from 0 to 30 ppmw of the at least one electrolyte based on the total amount of the aqueous medium (AM).

Another object of the present invention is therefore a method, wherein the aqueous medium (AM) comprises from 0 to 70 ppmw of the at least one electrolyte, based on the total weight of the aqueous medium (AM) and wherein the ppmw of the at least one electrolyte comprised in the aqueous medium (AM) are smaller than the % by weight of the at least one electrolyte comprised in the electrolyte-containing aqueous medium (EAM).

To the person skilled in the art, it should be clear that the aqueous medium (AM) comprises the same at least one electrolyte that was comprised in the electrolyte-containing aqueous medium (EAM) and in the dialyzed aqueous medium. Therefore, for the at least one electrolyte comprised in the aqueous medium (AM) the embodiments and preferences given above for the at least one electrolyte comprised in the electrolyte-containing aqueous medium (EAM) hold true.

It should be clear to the skilled person that the amount of the at least one electrolyte comprised in the aqueous medium (AM) is lower than the amount of the at least one electrolyte comprised in the electrolyte-containing aqueous medium (EAM).

Another object of the present invention is therefore a method, wherein the amount of the at least one electrolyte comprised in the aqueous medium (AM) is lower than the amount of the at least one electrolyte comprised in the electrolyte-containing aqueous medium (EAM).

The aqueous medium (AM) comprises water. In one embodiment, the aqueous medium (AM) essentially consists of water, the polyacrylic acid (PAA) and optionally the residues of the at least one electrolyte.

In another embodiment, the aqueous medium (AM) consists of water, the polyacrylic acid (PAA) and optionally the residues of the at least one electrolyte.

In the context of the present invention, the term “essentially consists” means that beside water, the polyacrylic acid (PAA) and optionally the residues of the at least one electrolyte, the aqueous medium (AM) comprises at most 1% by weight, preferably at most 0.5% by weight and more preferably at most 0.1% by weight of the substances, based on the total weight of the aqueous medium (AM).

The ppmw of the polyacrylic acid (PAA), the % by weight of water and optionally the ppmw of the residues of the at least one electrolyte comprised in the aqueous medium (AM) usually add up to 100%.

The temperature of the aqueous medium (AM) is generally in the range from >0 to <100° C. Preferably, the temperature of the aqueous medium (AM) is in the range from 5 to 95° C. and particularly preferably in the range from 10 to 50° C.

The aqueous medium (AM) can have any pH-value. Preferably, the pH-value of the aqueous medium (AM) is in the range from 5 to 9, particularly preferably in the range from 6 to 8 and more preferably in the range from 6.5 to 7.5.

The conductivity of the aqueous medium (AM) is in one embodiment of the present invention in the range from 0.1 to 100 μS/cm², preferably in the range from 0.1 to 80 μS/cm², particularly in the range from 0.1 to 60 μS/cm² and more preferably in the range from 0.1 to 30 μS/cm².

In another embodiment of the present invention the conductivity of the aqueous medium (AM) is in the range from 0.1 to 1000 μS/cm².

It should be clear to the person skilled in the art, that the conductivity of the aqueous medium (AM) is lower than the conductivity of the electrolyte-containing aqueous medium (EAM) as the aqueous medium (AM) comprises a lower amount of the at least one electrolyte than the electrolyte-containing aqueous medium (EAM).

In one embodiment of the present invention the aqueous medium (AM) obtained in step a3) is recycled to step a2) as the electrolyte-containing aqueous medium (EAM).

Another object of the present invention is therefore a method, wherein the aqueous medium (AM) obtained in step a3) is recycled to step a2) as the electrolyte-containing aqueous medium (EAM).

In this embodiment of the invention the aqueous medium (AM) obtained in step a3) is transferred to step a2) and is used as the electrolyte-containing aqueous medium (EAM) and passed through the dialysis unit according to step a2).

In another embodiment of the present invention the aqueous medium (AM) obtained in step a3) is recycled to step a2) as the electrolyte-containing aqueous medium (EAM) 1 to 1000 times, preferably 10 to 500 times and particularly preferably 50 to 300 times.

In one embodiment of the present invention in step a3) the conductivity of the aqueous medium (AM) is measured.

Methods to measure the conductivity of the aqueous medium (AM) in step a3) are known to the skilled person.

In one embodiment of the present invention in step a3) the conductivity of the aqueous medium (AM) is <100 μS/cm², preferably <80 μS/cm², particularly preferably <60 μS/cm² and more preferably <30 μS/cm².

In another embodiment of the present invention in step a3) the conductivity of the aqueous medium (AM) is <1000 μS/cm².

Another object of the present invention is therefore a method, wherein in step a3) the conductivity of the aqueous medium (AM) is <100 μS/cm².

Another object of the present invention is therefore a method, wherein in step a3) the conductivity of the aqueous medium (AM) is <1000 μS/cm².

In another embodiment of the present invention in step a3) the conductivity of the aqueous medium (AM) is in the range from 0.1 to 100 μS/cm², preferably from 0.1 to 80 μS/cm², particularly preferably from 0.1 to 60 μS/cm² and more preferably from 0.1 to 30 μS/cm².

In another embodiment of the present invention in step a3) the conductivity of the aqueous medium (AM) is in the range from 0.1 to 1000 μS/cm².

In one embodiment the aqueous medium (AM) obtained in step a3) is recycled to step a2) as the electrolyte-containing aqueous medium (EAM) until the conductivity of the aqueous medium (AM) in step a3) is <100 μS/cm², preferably <80 μS/cm², particularly preferably <60 μS/cm² and more preferably <30 μS/cm².

In one embodiment the aqueous medium (AM) obtained in step a3) is recycled to step a2) as the electrolyte-containing aqueous medium (EAM) until the conductivity of the aqueous medium (AM) in step a3) is <1000 μS/cm².

In another embodiment the aqueous medium (AM) obtained in step a3) is recycled to step a2) as the electrolyte-containing aqueous medium (EAM) until the conductivity of the aqueous medium (AM) in step a3) is in the range from 0.1 to 100 μS/cm², preferably from 0.1 to 80 μS/cm², particularly preferably from 0.1 to 60 μS/cm² and more preferably from 0.1 to 30 μS/cm²

In another embodiment the aqueous medium (AM) obtained in step a3) is recycled to step a2) as the electrolyte-containing aqueous medium (EAM) until the conductivity of the aqueous medium (AM) in step a3) is in the range from 0.1 to 1000 μS/cm².

Step b)

In step b) of the present invention a dye (I) is added to the aqueous medium (AM) to obtain a dye-containing aqueous medium (DAM), which comprises the polyacrylic acid (PAA), the dye (I) and optionally a residue of the at least one electrolyte.

The dye (I) can be added to the aqueous medium (AM) by any method and in any form known to the skilled person. For example the dye (I) can be added to the aqueous medium (AM) in solid form or as a solution comprising the dye (I) and a solvent. Preferably, the dye (I) is added as a solution.

The solution usually comprises from 1 to 1000 ppm by weight of the dye (I), preferably from 10 to 500 ppm by weight of the dye (I) and particularly preferably from 50 to 200 ppm by weight of the dye (I) based on the total amount of the solution.

The % by weight of the dye (I) and of the solvent comprised in the solution generally add up to 100%.

Suitable solvents are known to the skilled person. Preferably, the solvent does not exhibit a miscibility gap with water. Particularly preferably, the solvent is selected from the group consisting of water, methanol and ethanol.

The dye-containing aqueous medium (DAM) obtained in step b) comprises the polyacrylic acid (PAA) and the dye (I).

The dye-containing aqueous medium (DAM) usually comprises the same polyacrylic acid (PAA) as the aqueous medium (AM), which is provided in step a). Therefore, for the polyacrylic acid (PAA), which is comprised in the dye-containing aqueous medium (DAM), the same embodiments and preferences hold true as stated above for the polyacrylic acid (PAA), which is comprised in the aqueous medium (AM).

The dye-containing aqueous medium (DAM) furthermore comprises the dye (I). The dye-containing aqueous medium (DAM) usually comprises in the range from 1 to 100 ppmw of the dye (I), preferably from 1 to 50 ppmw of the dye (I) and particularly preferably from 1 to 20 ppmw of the dye (I) based on the total amount of the dye-containing aqueous medium (DAM).

The dye-containing aqueous medium (DAM) usually furthermore comprises water. For the water comprised in the dye-containing aqueous medium (DAM), the embodiments and preferences concerning the aqueous medium (AM), as stated above, hold true.

To the person skilled in the art it is clear that the dye-containing aqueous medium (DAM) furthermore comprises the solvent, if the dye (I) is added to the aqueous medium (AM) dissolved in the solvent.

Furthermore, if the aqueous medium (AM) provided in step a) comprises a residue of the at least one electrolyte, then the dye-containing aqueous medium (DAM) also comprises a residue of the at least one electrolyte. The residue of the at least one electrolyte comprised in the dye-containing aqueous medium (DAM) is the same as the residue of the at least one electrolyte comprised in the aqueous medium (AM). Therefore, for the at least one electrolyte comprised in the dye-containing aqueous medium (DAM) the embodiments and preferences given above hold true.

Dye (I)

According to the present invention the substituents of the dye (I) have the following meanings.
R¹ is selected from the group consisting of H, C₁-C₁₀-alkyl, C₆-C₁₀-aryl and NR⁵R⁶,
wherein
R⁵ and R⁶ are independently of one another selected from the group consisting of H, C₁-C₁₀-alkyl and C₆-C₁₀-aryl;
R² is selected from the group consisting of H, C₁-C₁₀-alkyl, C₆-C₁₀-aryl and NR⁷R⁸,
wherein
R⁷ and R⁸ are independently of one another selected from the group consisting of H, C₁-C₁₀-alkyl and C₆-C₁₀-aryl;
R³ is selected from the group consisting of H, C₁-C₁₀-alkyl, C₆-C₁₀-aryl and NR⁹R¹⁰,
wherein
R⁹ and R¹° are independently of one another selected from the group consisting of H, C₁-C₁₀-alkyl and C₆-C₁₀-aryl;
R⁴ is selected from the group consisting of H, C₁-0₁₀-alkyl, C₆-C₁₀-aryl and NR11R¹²,
wherein
R¹¹ and R¹² are independently of one another selected from the group consisting of H, C₁-C₁₀-alkyl and C₆-C₁₀-aryl;
X⁺ is selected from the group consisting of NH⁺, O⁺ and S⁺;
Y is N or CH;
Z⁻ is selected from the group consisting of OH⁻, F⁻, Cl⁻, Br⁻, I⁻, SO₄²⁻, PO₄³⁻, HCO₃⁻ and CO₃²⁻.

“C₁-C₁₀-alkyl” within the context of the present invention means a saturated or unsaturated hydrocarbon having a free valence (radical) and from 1 to 10 carbon atoms. The carbon atoms can be linear, branched or cyclic. It is also possible that the hydrocarbons comprise a cyclic and a linear component. Examples for C₁-C₁₀-alkyl groups are methyl, ethyl, n-propyl, iso-propyl, n-butyl, iso-butyl, sec-butyl, tert-butyl, hexyl and cyclohexyl. The same definition holds true for C₁-C₅-alkyl.

“C₆-C₁₀-aryl” within the context of the present invention means an aromatic hydrocarbon having from 6 to 10 carbon atoms and a free valence (radical). The substituent (radical) is, therefore, an aromatic. The aromatic can be monocyclic or bicyclic. Examples of aryl groups are phenyl and naphthyl like 1-naphthyl and 2-naphthyl.

In a preferred embodiment, the substituents of the dye (I) have the following meanings:

R¹ is selected from the group consisting of H, C₁-C₅-alkyl and NR⁵R⁶,
wherein
R⁵ and R⁶ are independently of one another selected from the group consisting of H and C₁-C₅-alkyl;
R² is selected from the group consisting of H, C₁-C₅-alkyl and NR⁷R⁸,
wherein
R⁷ and R⁸ are independently of one another selected from the group consisting of H and C₁-C₅-alkyl;
R³ is selected from the group consisting of H, C₁-C₅-alkyl and NR⁹R¹⁰,
wherein
R⁹ and R¹⁰ are independently of one another selected from the group consisting of H and C₁-C₅-alkyl;
R⁴ is selected from the group consisting of H, C₁-C₅-alkyl and NR¹¹R¹²,
wherein
R¹¹ and R¹² are independently of one another selected from the group consisting of H and C₁-C₅-alkyl;
X⁺ is selected from the group consisting of NH⁺, O⁺ and S⁺;
Y is N or CH;
Z⁻ is selected from the group consisting of OH⁻, F⁻, Cl⁻, Br⁻ and I⁻.

In a particularly preferred embodiment, the substituents of the dye (I) have the following 15 meanings:
R¹ is selected from the group consisting of methyl, ethyl and NR⁵R⁶,
wherein
R⁵ and R⁶ are independently of one another selected from the group consisting of H, methyl and ethyl;
R² is selected from the group consisting of H, methyl and ethyl,
R³ is selected from the group consisting of methyl, ethyl and NR⁹R¹⁰,
wherein
R⁹ and R¹⁰ are independently of one another selected from the group consisting of H, methyl and ethyl;
R⁴ is selected from the group consisting of H, methyl and ethyl,
X⁺ is selected from the group consisting of NH⁺, O⁺ and S⁺;
Y is N or CH;
Z⁻ is OH⁻ or Cl⁻.

In a more preferred embodiment, the dye (I) is selected from the group consisting of a dye of formula (Ia), a dye of formula (Ib) and a dye of formula (Ic):

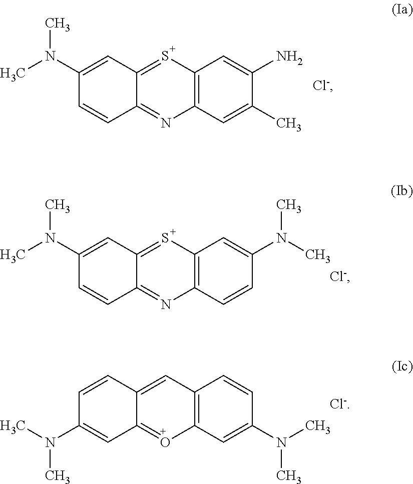

To the person skilled in the art it should be clear that there exist mesomeric formulas of the dye (I), the dye (Ia), the dye (Ib) and the dye (Ic). For example, a mesomeric formula of dye (Ia) is formula (Iai), of dye (Ib) is formula (Ibi) and of dye (Ic) is formula (Ici).

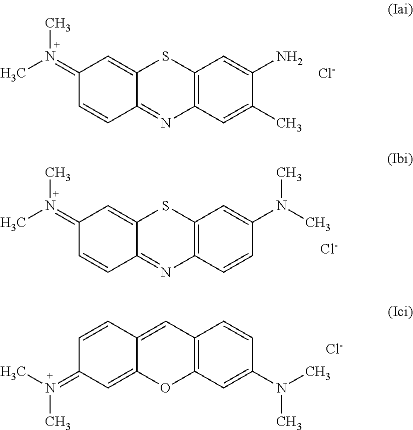

Therefore, the dye of the general formula (I), the dye of formula (Ia), the dye of formula (Ib) and the dye of formula (Ic) also comprise the mesomeric formulas of the general formula (I), of formula (Ia), of formula (Ib) and of formula (Ic).

The dye (Ia) is also known as toluidine blue O or Basic Blue 17 (Color index number 52040). Another name of dye (la) is tolonium chloride. Its IUPAC name is 3-amino-7-(dimethylamino)-2-methylphenothiazin-5-ium chloride and its CAS-number is 92-31-0.

The dye (Ib) is also known as methylene blue or Basic Blue 9 (Color index number 52015). Its IUPAC name is 3,7-bis(dimethylamino)-phenothiazine-5-ium chloride and its CAS-number is 61-73-4.

The dye (Ic) is also known as pyronin G, Pyronin Y or Pyronin J (Color index number 45005) and has the CAS-number 92-32-0.

Another object of the present invention is, therefore, a method wherein the dye (I) is selected from the group consisting of toluidine blue O, methylene blue and pyronin G. In a particularly preferred embodiment the dye (I) is toluidine blue O.

Another object of the present invention is therefore a method, wherein the dye (I) is toluidine blue O.

The dye (I) comprises dyes that exhibit a structure according to formula (I) in their solid state. The dye (I) as well comprises dyes that exhibit the structure according to the general formula (I) only when they are solved in water, as they are protonated in water. For example the dye proflavin is as well comprised in the general formula (I). Proflavin in its solid state is a dye of the formula (Id).

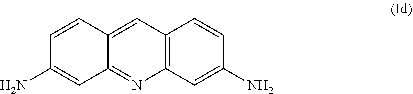

When adding proflavin to water, a nitrogen atom is protonated and, therefore, in an aqueous medium (AM) proflavin has the formula (Idi), which is a specific structure of the general formula (I).

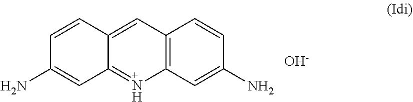

Step c)

In step c) the dye-containing aqueous medium (DAM) obtained in step b) is provided to a photometer.

Suitable photometers are any photometers known to the skilled person, which are suitable for measuring in the UV/Vis-range. This means that the photometer uses light in the UV/Vis-range and can detect light in the UV/Vis-range.

The UV/Vis-range is usually in the range from 180 to 800 nm, preferably from 200 to 780 nm.

In a preferred embodiment of the present invention an UV/Vis-spectrometer is used as photometer. Particularly preferably a diode array spectrometer is used. A suitable spectrometer is for example an Agilent HP8453.

A photometer usually comprises at least one light source, at least one sample holder and at least one detector.

Any light source emitting light in the UV/Vis-range can be used as light source. The light source can emit a continuous spectrum or a discontinuous spectrum. Light sources that emit a discontinuous spectrum are preferred.

A light source that emits a continuous spectrum within the context of the present invention means that the light source produces light at every wavelength in the UV/Vis range. A light source that emits a continuous spectrum is also called a continuous light source within the context of the present invention.

Continuous light sources are for example tungsten filaments, deuterium arc lamps and xenon arc lamps.

A light source that emits a discontinuous spectrum within the context of the present invention means that at some wavelength of the UV/Vis-range, the light source does not emit light. A light source that emits a discontinuous spectrum is also called a discontinuous light source within the context of the present invention.

Discontinuous light sources are for example light emitting diodes (LEDs).

If the light source emits light only in a small range of wavelengths, for example a range from 1 to 100 nm, preferably from 1 to 80 nm and particularly preferably from 1 to 65 nm, then the light source is called a light source that emits a discrete spectrum. Within the context of the present invention, a light source that emits a discrete spectrum is also called a discrete light source.

In a particularly preferred embodiment of the present invention a light source that emits a discrete spectrum is used.

Discrete light sources are for example light emitting diodes (LEDs). Light emitting diodes (LEDs) are preferred as discrete light source.

If a discrete light source is used, usually at least two different discrete light sources, which emit light having two different wavelengths are used. For example, if a diode is used as light source, then at least two different diodes are used, that emit light of two different wavelengths. For example, a first diode that emits light in the range from 520 to 550 nm and a second diode that emits light in the range from 553 to 585 nm.

Therefore in one embodiment of the present invention at least two different discrete light sources are used. In a preferred embodiment of the present invention, a least two different diodes are used.

Suitable sample holders are known to the skilled person. Preferred sample holders according to the present invention are selected from cuvettes and flow cells.

Suitable cuvettes are known to the skilled person, for example the cuvettes can be made of glass, plastic or fused quartz.

Suitable flow cells are known to the skilled person. The thickness of the sample holder, preferably of the flow cell, is generally in the range from 0.1 to 10 cm.

Therefore, in one embodiment of the present invention, in step c) the dye-containing aqueous medium (DAM) is provided into a cuvette or into a flow cell, preferably into a flow cell comprised in the photometer.

As detector any detector, which can detect light in the US/Vis-range can be used. Suitable detectors are for example a photomultiplier tube, a photodiode, a photodiode array or a charge coupled device (CCD).

In one embodiment of the present invention the dye (I) is added to the aqueous medium (AM), while the aqueous medium (AM) is provided to the photometer.

In this embodiment step b) and step c) are carried out simultaneously.

Another object of the present invention is therefore a method wherein step b) and step c) are carried out simultaneously.

Step d)

According to step d), at least two different wavelengths are used to measure at least two different transmittance values of the dye-containing aqueous medium (DAM) using the photometer.

To the person skilled in the art it should be clear that the at least two different transmittance values can have the same numerical value. However, even if the at least two different transmittance values have the same numerical value, they are measured using at least two different wavelengths.

“At least two different wavelengths” within the context of the present invention means precisely two different wavelengths and also three or more different wavelengths.

The at least two different wavelengths used can be emitted from at least one one continuous light source, at least one discontinuous light source or from at least two different discrete light sources. At least two different discrete light sources are preferred.

If discrete light sources are used, then usually as many discrete light sources are used as wavelengths are used. If, for example, two different wavelengths are used, then two different discrete light sources are used. If, for example four different wavelengths are used, then four different discrete light sources are used.

Any at least two different wavelengths are suitable to be used in step d). Preferably, at least two different wavelengths are used, at which the extinction spectrum of a reference sample comprising the aqueous medium (AM), the dye (I) and, optionally, the polyacrylic acid (PAA), measured with a continuous light source or a discontinuous light source exhibits a maximum, or at which the isosbestic point lies. The isosbestic point describes a specific wavelength, at which the extinction of a dye-containing aqueous medium (DAM) does not change when changing the concentration of the polyacrylic acid (PAA) and, optionally, the dye (I) comprised in the dye-containing aqueous medium (DAM). The extinction is also known as absorbance. To the person skilled in the art, it should be clear that at the wave lengths at which the extinction spectrum exhibits a maximum, the corresponding transmittance spectrum exhibits a minimum.

Therefore, to determine suitable at least two different wavelengths, preferably an UV/Vis-spectrum of a reference sample comprising the dye (I), the aqueous medium (AM), and, optionally, the polyacrylic acid (PAA) is measured using a continuous light source or a discontinuous light source, before the determination of the concentration of the polyacrylic acid (PAA) according to the present invention.

In one embodiment of the present invention, a first wavelength and a second wavelength is used in step d). In one embodiment of the present invention, the first wavelength is in the range from 180 to 700 nm, preferably in the range from 200 to 600 nm and particularly preferably in the range from 400 to 580 nm, and the second wavelength is in the range from 200 to 800 nm, preferably from 400 to 650 nm and particularly preferably in the range from 500 to 600 nm.

Another object of the present invention is therefore a method, wherein a first wavelength and a second wavelength is used in step d) and wherein the first wavelength is in the range from 180 to 700 nm and the second wavelength is in the range from 200 to 800 nm and wherein the first wavelength and the second wavelength are different from each other.

It should be clear that the wavelength of the first wavelength is smaller than the wavelength of the second wavelength.

Another object of the present invention is therefore a method, wherein the wavelength of the first wavelength is smaller than the wavelength of the second wavelength.

In a further preferred embodiment the first wavelength is in the range from 553 to 585 nm and the second wave length is in the range from 620 to 652 nm.

Another object of the present invention is therefore a method, wherein a first wavelength and a second wavelength is used in step d) and wherein the first wavelength is in the range from 553 to 585 nm and the second wavelength is in the range from 620 to 652 nm.

If the first wavelength is in the range from 553 to 585 nm and the second wavelength is in the range from 620 to 652 nm, it is particularly preferred, that the dye (I) comprises toluidine blue O.

Another object of the present invention is therefore a method, wherein the dye (I) is toluidine blue O and wherein a first and a second wavelength is used in step d), wherein the first wavelength is in the range from 553 to 585 nm and the second wavelength is in the range from 620 to 652 nm.

In step d) at least two different transmittance values are measured.

To the person skilled in the art it should be clear that in step d) as many transmittance values are obtained as different wavelengths are used. If, for example, two different wavelengths are used, then two transmittance values are obtained. If, for example four different wavelength are used, then four transmittance values are obtained.

If a continuous light source is used, then usually at least two different wavelengths and the at least two transmittance values obtained at these at least two wavelengths are selected from the continuous spectrum. A similar approach is performed if a discontinuous light source is used. If a discrete light source is used, then typically at least two discrete light sources are used which emit at least two different wavelengths. Using these at least two different wavelengths, at least two transmittance values are obtained.

It is also possible to measure at least two extinction values or at least two absorption values. The person skilled in the art knows that extinction values as well as absorption values can be converted to transmittance values using the Beer-Lambert Law.

According to the Beer-Lambert Law, the transmittance (T) is defined as

T=I/I₀=10^{-ε·c·d}

the extinction (E) is defined as

E=log I₀/I=ε·c·d=−log T

and the absorption (A) is defined as

A=1−T
I₀ is the intensity of the incident radiation,
I is the intensity of the transmitted radiation,
ϵ is the molar absorption coefficient,
c is the concentration of the absorbing species,
d is the path length of the light through the flow cell.

Step e)

In step e) the at least two different transmittance values obtained in step d) are analyzed to determine the concentration (C) of the polyacrylic acid (PAA).

For the determination of the concentration (C) of the polyacrylic acid (PAA) by analyzing the at least two transmittance values generally the use of a calibration curve is necessary.

The calibration curve preferably is determined by using at least two different solutions, preferably at least five solutions, which comprise the dye (I) and different known concentrations (C) of the polyacrylic acid (PAA) in the same at least one solvent that is comprised in the aqueous medium (AM). For each of the at least two different solutions at least two different transmittance values are determined using the same at least two different wavelengths as in step d) of the inventive process. For example a first transmittance value (t1) and a second transmittance value (t2) are obtained using a first wavelength (λ1) and a second wavelength (λ2).

Then for each of the at least two different solutions the ratio of two different transmittance values, for example of a first transmittance value (t1) and a second transmittance value (t2), of the at least two different transmittance values obtained according to step d) is determined. In other words, the ratio (t1/t2) of a first transmittance value (t1) and a second transmittance value (t2) obtained by using a first wavelength (λ1) and a second wavelength (λ2) is determined for each of the at least two different solutions.

This ratio (t1/t2) is plotted versus the concentration (C) of the polyacrylic acid (PAA) comprised in the at least two different solutions. The calibration curve is then obtained via linear regression. Methods for the linear regression are known to the skilled person.

In step e) the ratio of two different transmittance values of the at least two different transmittance values measured in step d) is determined. The two different transmittance values of which the ratio is determined are obtained using the same two different wavelengths of the at least two different wavelengths, that were used to measure the two different transmittance values of the two different solutions of the calibration curve. With this ratio using the calibration curve, the concentration (C) of the polyacrylic acid (PAA) can be determined.

The present invention is illustrated below by reference to examples without limitation thereto.

### EXAMPLES

### Example 1: Precision of the Inventive Process

To determine the precision of the inventive process over a longer period of time, the concentration (C) of a polyacrylic acid (PAA) is measured for 50 hours. Sea water comprising as the at least one electrolyte 3.5% by weight of sea salt (Italian sea salt, Orto Mio) is used as electrolyte-containing aqueous medium (EAM). The sea water additionally comprises 4 ppmw of polyacrylic acid (PAA) (Sokalan PM 15 I).

The sea water is passed through a dialysis unit (step a2)) to obtain the dialyzed aqueous medium and then transferred to a vessel, wherein deionized water is added (step a3)) to obtain the aqueous medium (AM). The aqueous medium (AM) is recycled from the vessel (step a3)) to the dialysis unit as electrolyte-containing aqueous medium (EAM) (step a2)) until the conductivity of the aqueous medium (AM) measured in the vessel is 30 μS/cm².

Then 1.21 ppmw of toluidine blue O (dye (I)) are added to the aqueous medium (AM) and the thus obtained dye-containing aqueous medium (DAM) is provided to a photometer. The photometer is a diode array spectrometer comprising two diodes. The first diode has a wavelength of 569 nm and the second diode has a wavelength of 536 nm. At these two different wavelengths two transmittance values of the aqueous medium (AM) are measured (step d)). A first transmittance value and a second transmittance value are obtained.

The concentration (C) of the polyacrylic acid (PAA) is determined by the determination of the ratio of the first transmittance value to the second transmittance value using a calibration curve.

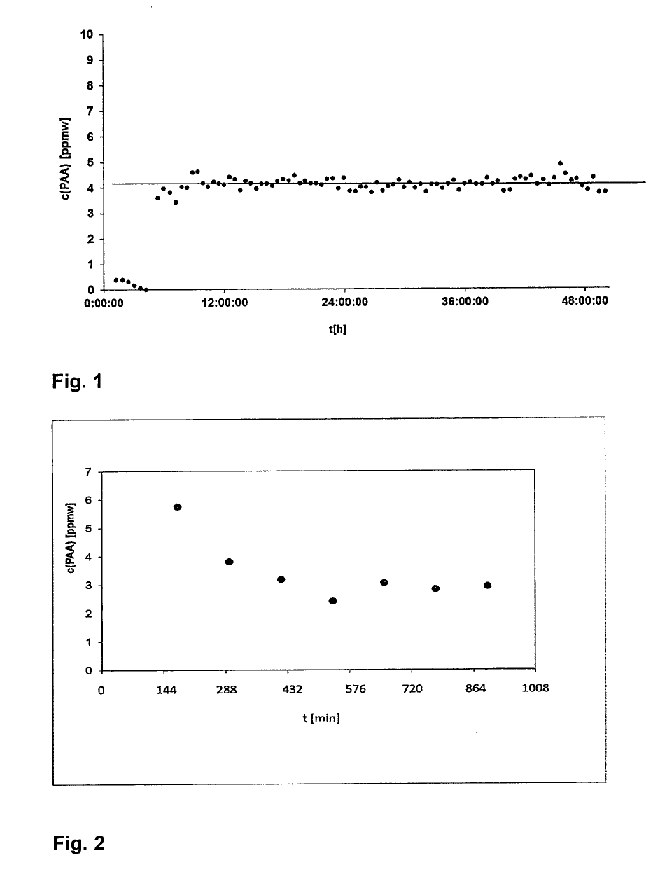

The results obtained can be found in FIG. 1. The x-axis gives the time (t) of the measurement in hours (h), the y-axis gives the concentration (c) of the polyacrylic acid (PAA) in ppmw. It can clearly be seen that the concentration (c) of 4 ppmw of a polyacrylic acid (PAA) can be determined very accurate with a standard deviation of ±2 ppmw.

This clearly shows that the inventive method is sufficient accurate to determine the concentration (C) of a polyacrylic acid (PAA) in an aqueous medium (AM).

The first six values in FIG. 1 are close to 0. This is because at the beginning of the measurement a sea salt solution is used without polyacrylic acid (PAA) to stabilize the measuring device.

### Example 2: Concentration (c) of a Polyacrylic Acid (PAA) in a Desalination Plant

An electrolyte-containing aqueous medium (EAM) from a process stream of a desalination plant is used. Natural sea water comprising 3.5% by weight of sea salt, which was concentrated to a concentration of 4.7% by weight (47000 ppmw) of sea salt, was used as electrolyte-containing aqueous medium (EAM). At the beginning, the electrolyte-containing aqueous medium (EAM) moreover comprises 10 ppmw of the polyacrylic acid (PAA) (Sokalan PM 15 I).

The drop of the concentration (c) of the polyacrylic acid (PAA) in the electrolyte-containing aqueous medium (EAM) is monitored over 12 hours every 144 minutes using the method as described in example 1.

FIG. 2 shows the results. The x-axis gives the time (t) in minutes (min) for which the measurements were carried out, the y-axis gives the concentration (c) of the polyacrylic acid (PAA) in ppmw.

FIG. 2 shows that the concentration (c) of the polyacrylic acid (PAA) drops within 12 hours from 10 ppmw to approximately 3 ppmw.

### Example 3: Concentration (c) of a Polyacrylic Acid (PAA) in a Water Circuit

An electrolyte-containing aqueous medium (EAM) from a process stream of a cooling water circuit is used. The cooling water circuit comprises two different strands (K1 and K2) of cooling water, to which the cooling water is added from the same cooling water pipe. 50 ppmw of the polyacrylic acid (PAA) (Antiprex AD 2020 S) are added to the cooling water pipe. Therefore, the two different strands should comprise the same concentration (c) of the polyacrylic acid (PAA).

Samples of the electrolyte-containing aqueous medium (EAM) of each of the two different strands of cooling water are taken every 30 minutes for 24 hours and are dialyzed as described above for example 1. Then 666 ppmw of toluidine blue O (dye (I)) are added to each of the samples. The measurement of the two transmittance values of each of the two samples and the analysing of the transmittance values is performed as described above for example 1.

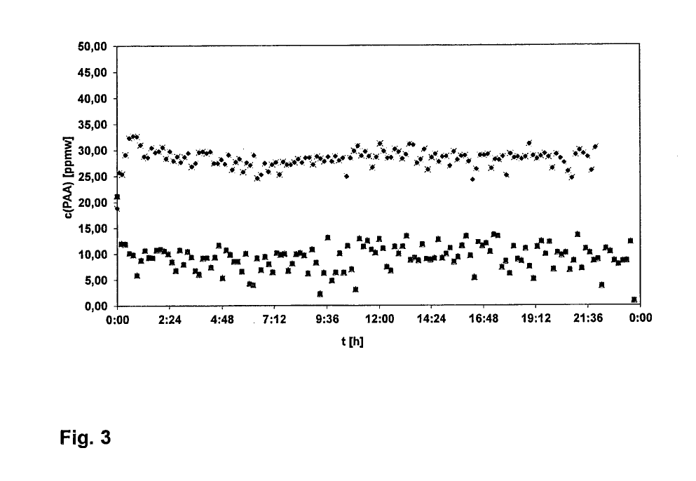

FIG. 3 shows the results. The x-axis gives the time (t) in hours (h) for which the measurements were carried out, the y-axis gives the concentration (c) of the polyacrylic acid (PAA) in ppmw. The diamonds give the results for strand K1, the squares give the results for strand K2.

FIG. 3 shows that the concentration of the polyacrylic acid (PAA) differs for the two different strands of cooling water. The difference in the concentration is a result from the uneven distribution of the cooling water from the cooling water pipe.

1-14. (canceled)

15. A method for the determination of a concentration (C) of a polyacrylic acid (PAA) in an aqueous medium (AM), which comprises the polyacrylic acid (PAA), wherein the determination is performed photometrically in the presence of a dye of the general formula (I) 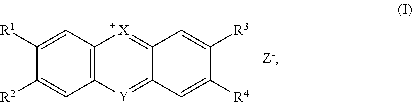
wherein
R¹ is selected from the group consisting of H, C₁-C₁₀-alkyl, C₆-C₁₀-aryl and NR⁵R⁶,
wherein
R⁵ and R⁶ are independently of one another selected from the group consisting of H, C₁-C₁₀-alkyl and C₆-C₁₀-aryl,
R² is selected from the group consisting of H, C₁-C₁₀-alkyl, C₆-C₁₀-aryl and NR⁷R⁸,
wherein
R⁷ and R⁸ are independently of one another selected from the group consisting of H, C₁-C₁₀-alkyl and C₆-C₁₀-aryl;
R³ is selected from the group consisting of H, C₁-C₁₀-alkyl, C₆-C₁₀-aryl and NR9R¹⁰,
wherein
R⁹ and R¹⁰ are independently of one another selected from the group consisting of H, C₁-C₁₀-alkyl and C₆-C₁₀-aryl;
R⁴ is selected from the group consisting of H, C₁-C₁₀-alkyl, C₆-C₁₀-aryl and NR¹¹R¹²,
wherein
R¹¹ and R¹² are independently of one another selected from the group consisting of H, C₁-C₁₀-alkyl and C₆-C₁₀-aryl;
X⁺ is selected from the group consisting of NH⁺, O⁺ and S⁺;
Y is N or CH;
Z⁻ is selected from the group consisting of OH⁻, F⁻, Cl⁻, Br⁻, I⁻, SO₄²⁻, PO₄³⁻, HCO₃⁻ and CO₃²⁻.
comprising the steps:
a) providing the aqueous medium (AM), which comprises the polyacrylic acid (PAA), comprising the steps:
a1) providing an electrolyte-containing aqueous medium (EAM), which comprises the polyacrylic acid (PAA) and at least one electrolyte,
a2) passing the electrolyte-containing aqueous medium (EAM) through a dialysis unit to give a dialyzed aqueous medium, which comprises the polyacrylic acid (PAA) and
a3) adding deionized water to the dialyzed aqueous medium obtained in step a2) to obtain the aqueous medium (AM),
b) addition of the dye (I) to the aqueous medium (AM) to obtain a dye-containing aqueous medium (DAM), which comprises the polyacrylic acid (PAA) and the dye (I),
c) providing the dye-containing aqueous medium (DAM) obtained in step b) to a photometer,
d) using at least two different wavelengths to measure at least two different transmittance values of the dye-containing aqueous medium (DAM) using the photometer and
e) analysing the at least two different transmittance values obtained in step d) to determine the concentration (C) of the polyacrylic acid (PAA).

16. The method according to claim 15, wherein step b) and step c) are carried out simultaneously.

17. The method according to claim 15, wherein in step a3) the conductivity of the aqueous medium (AM) is <1000 μS/cm².

18. The method according to claim 15, wherein the electrolyte-containing aqueous medium (EAM) comprises at least one electrolyte selected from the group consisting of an alkaline metal salt, an alkaline earth metal salt and mixtures thereof.

19. The method according to claim 15, wherein the electrolyte-containing aqueous medium (EAM) comprises from 0.001 to 10% by weight of the at least one electrolyte, based on the total amount of the electrolyte-containing aqueous medium (EAM).

20. The method according to claim 15, wherein the aqueous medium (AM) comprises a residue of the at least one electrolyte.

21. The method according to claim 20, wherein the aqueous medium (AM) comprises from 0 to 70 ppmw of the at least one electrolyte, based on the total weight of the aqueous medium (AM) and wherein the ppmw of the at least one electrolyte comprised in the aqueous medium (AM) are smaller than the % by weight of the at least one electrolyte comprised in the electrolyte-containing aqueous medium (EAM).

22. The method according to claim 15, wherein a first wavelength and a second wavelength is used in step d) and wherein the first wavelength is in the range from 180 to 700 nm and the second wavelength is in the range from 200 to 800 nm and wherein the first wavelength and the second wavelength are different from each other.

23. The method according to claim 15, wherein a first wavelength and a second wavelength is used in step d) and wherein the first wavelength is in the range from 553 to 585 nm and the second wavelength is in the range from 620 to 652 nm.

24. The method according to claim 15, wherein the dye (I) is toluidine blue O.

25. The method according to claim 15, wherein the aqueous medium (AM) comprises from 0.01 to 100 ppmw of the polyacrylic acid (PAA), based on the total weight of the aqueous medium (AM).

26. The method according to claim 15, wherein the polyacrylic acid (PAA) has a number average molecular weight Mₙ in the range from 1000 to 250 000 g/mol.

27. A method for the determination of a concentration (C) of a polyacrylic acid (PAA), said method comprising:
photometrically determining said concentration of (C) of (PAA) by using a dye (I).
